(19) United States
(12) Patent Application Publication
(10) Pub. No.: US 2006/0020414 A1
(43) Pub. Date: Jan. 26, 2006

(54) System and method for automatically allocating MAC addresses to network cards

(75) Inventor: Yi-Hong Jiang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/116,754

(22) Filed: Apr. 28, 2005

(30) Foreign Application Priority Data
May 15, 2004 (CN) 200410027267.6

(51) Int. Cl. G01M 19/00

(52) U.S. Cl. 702/122

(57) ABSTRACT

A system for automatically allocating MAC addresses to network cards is disclosed. The system provides an MAC address server, a plurality of client computers and a plurality of testing machines. The MAC address server provides a searching module, a reading module, a checking module and a creating module. Each of the client computers comprises: a recording module, a file creating module, a file obtaining module, and a determining module. A method for automatically allocating MAC addresses to network cards is also disclosed.

### CROSS-REFERENCE OF RELATED APPLICATION

This application is related to copending U.S. patent application entitled “Method for Burning MAC Address” filed on Nov. 24, 2004 and accorded Ser. No. is 10/997,573.

### BACKGROUND OF THE INVENTION

1. Field of the Invention

The present invention relates generally to methods for address allocation, and more particularly, to a method for automatically allocating MAC addresses to network cards on mainboards.

2. General Background

Every network card has its own unique address, commonly known as an MAC (Media Access Control) address. The manufacturer assigns MAC addresses at the time of fabrication. MAC addresses are used for mapping in Transmission Control Protocol/Internet Protocol network communication, and are typically 48 bits in length expressed by 12 hexadecimal digits (0-9, A-F, capitalized). Each MAC address can be further divided into 6 bytes. The first three bytes of the MAC address are unique to the manufacturer thus identifying the manufacturer of the card. The remaining three bytes is the card's serial number, unique to the card.

When the manufacturer allocates an MAC address to fabricate a network card integrated on a mainboard, very often the MAC address has been allocated to another network card by a worker, causing many man-made mistakes and disadvantages, such as file missing, viruses, complicated processes, etc.

As the manufacturer suffers high costs and low efficiency, what is needed, therefore, is a system and method for automatically allocating MAC addresses to network cards, which can reduce man-made mistakes and other disadvantages.

### SUMMARY

One preferred embodiment provides a system for automatically allocating MAC addresses to network cards. The system includes: a plurality of testing machines for recording the MAC addresses on the network cards; an MAC address server includes a database for storing MAC address information, and a network folder for storing kinds of designated format files used in the recording process; a plurality of client computers connected to the testing machines and the MAC address server for controlling the testing machines to record the MAC addresses on the network cards and verify the MAC addresses.

In this preferred embodiment, the designated format files includes: query files for requesting the MAC address server to allocate the MAC addresses to the network cards; flag files used as marks denoting that corresponding query files have been created; eth files for storing the MAC addresses; and error files for recording errors occurring in the recording of the MAC addresses.

The MAC address server includes: a searching module for searching a flag file in the network folder according to a request of recording an MAC address to a network card from a client computer; a reading module for opening a query file corresponding to the flag file and reading a mainboard serial number from a mainboard serial number table; a checking module for checking whether an MAC address has been recorded on the network card; and a creating module for creating an eth file including an MAC address obtained and an error file when any error occurs during the recording of the MAC address on the network card.

Each of the client computers includes: a recording module for sending the request of recording an MAC address to a network card to the MAC address server; a file creating module for creating the query file and the flag file; a file obtaining module for obtaining the eth file and the error file from the MAC address server; a determining module for determining whether the MAC address included in the .eth file is identical to a corresponding MAC address in a BIOS (Basic Input/Output System) of the mainboard; and a verifying module for sending a request to the MAC address server for verifying the MAC address recorded on the network card.

Another preferred embodiment provides a method for automatically allocating an MAC address to a network card. The method includes the steps: obtaining a serial number of the mainboard; creating a query file and a flag file; checking whether the serial number of the mainboard exists in a mainboard serial number table; checking whether the network card has been recorded an MAC address if the mainboard serial number exits in the mainboard serial number; obtaining a new MAC address from an MAC address range table if the network card has not been recorded an MAC address; deleting the query file and the flag file; recording the MAC address on the network card; and checking the MAC address on the networkcard.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic diagram of hardware configuration of a system for automatically allocating MAC addresses to network cards in accordance with a preferred embodiment of the present invention;

FIG. 2 is a schematic diagram illustrating function modules of a client computer of the system of FIG. 1;

FIG. 3 is schematic diagram illustrating function modules of an MAC address server of the system of FIG. 1;

FIG. 4 shows details of an MAC address range table stored in a database;

FIG. 5 shows details of a .qry file;

FIG. 6 shows details of an eth file;

FIG. 7 is a flowchart of a preferred method for automatically allocating an MAC address to a network card;

FIG. 8 is a flowchart of details of one step of FIG. 7, namely, checking whether an MAC address recorded is correct; and

FIG. 9 is a flowchart of details of another step of FIG. 7, namely, obtaining an MAC address from an MAC address range table.

### DETAILED DESCRIPTION OF THE INVENTION

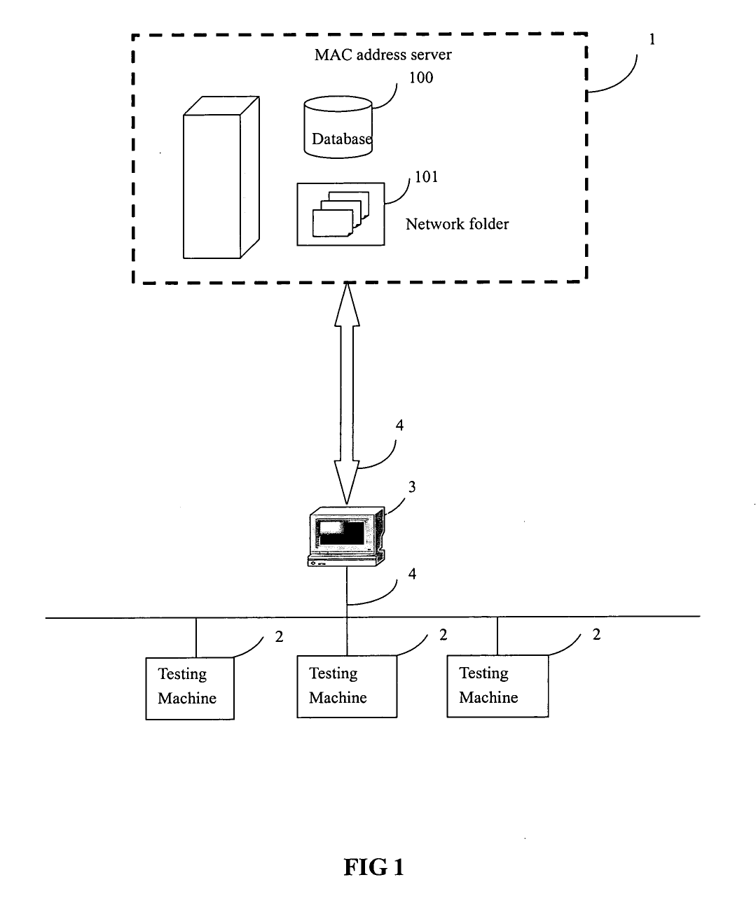

Referring to FIG. 1, an MAC (Media Access Control) address server 1 is connected to distributed client computers 3 (only one shown) by a network 4. The client computers 3 are further connected to a plurality of testing machines 2 through the network 4. The MAC address server 1 has had many function modules installed therein, and includes a database 100 and a network folder 101. The database 100 is for storage of MAC address information. The network folder 101 stores kinds of designated format files that are named in accordance with corresponding client computers 3. Such designated format files, in a preferred embodiment, typically include: .qry files (described in detail in relation to FIG. 5), which are used to request the MAC address server 1 to allocate MAC addresses to network cards on mainboards; flg files, each of which is empty and used as a mark denoting that a corresponding .qry file has been created; .eth files (described in detail in relation to FIG. 6) for storing MAC addresses obtained; and err files for recording errors during the recording of MAC addresses on the mainboards. Contents of an .err file may include:

04M233800085

00016C257BD4

ERROR MSG: This MAC Address has been used by another mainboard, whose SN is 04M233800085 and MAC address is 00016C257BD4. The network folder 101 can accelerate the access to these designated format files.

The database 100 stores an MAC address range table and MAC address tables. Each MAC address table includes columns for recording a mainborad serial number, an MAC address and a manufacturer code. The mainboard serial number and MAC address are both unique to a corresponding mainboard. The database 100 also stores a mainboard serial number table transmitted by a Shopping Floor Control system (not shown). The mainboard serial number table has at least two columns, respectively for recording mainboard serial numbers and MAC addresses. Each mainboard serial number corresponds to a unique MAC address after the MAC address has been recorded on the mainboard.

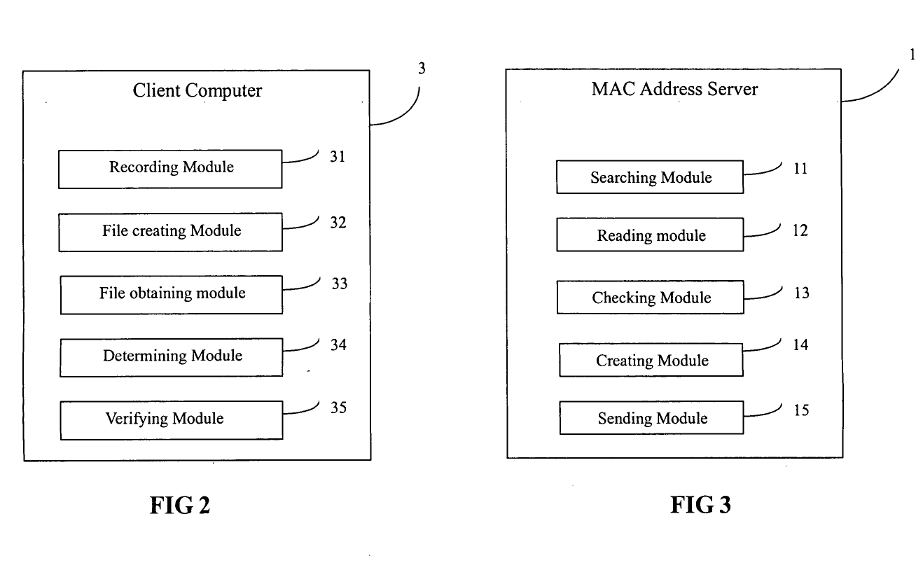

Each client computer 3 provides a plurality of function modules (described in detail in FIG. 2) to control the testing machines 2. The testing machines 2 can test performances of various mainboards and record MAC addresses on the mainboards.

Referring to FIG. 2, there is shown function modules of any one of the client computers 3. The client computer 3 includes: a recording module 31 for controlling corresponding testing machines 2 to record MAC addresses on network cards, and for transmitting and reading relevant files or data; a file creating module 32 for creating .qry files and flg files; a file obtaining module 33 used for obtaining eth files and err files from the MAC address server 1, and for transmitting the MAC addresses to the database 100; a determining module 34 for determining whether an MAC address included in an .eth file is identical to a corresponding MAC address in a BIOS (Basic Input/Output System) of a mainboard; and a verifying module 35 for sending a request to the MAC address server 1 for verifying whether an MAC address recorded on a mainboard is correct.

Referring to FIG. 3, there is shown function modules of the MAC address server 1. A searching module 11 is used to search a flg file in the network folder 101 according to a recording request received from the client computer 3. The searching module 11 may also be used to search new MAC addresses in the MAC address range table. A reading module 12 is used to open and read a particular .qry file, and obtain a corresponding mainboard serial number from the mainboard serial number table. A checking module 13 is used to check whether a mainboard serial number exists in the mainboard serial number table, and check whether an MAC address has been recorded on a mainboard. If the MAC address has been recorded on the mainboard, the MAC address can be found in the mainboard serial number table. If no MAC address has been recorded on the mainboard, the checking module 13 obtains a new MAC address from the MAC address range table. The checking module 13 can also be used to check whether MAC addresses in an MAC address block have been used up. A creating module 14 is used to create .eth files, and create an .err file when the checking module 13 checks that a particular mainboard serial number does not exist in the mainboard serial number table. A sending module 15 is used to send eth files and err files created by the creating module 14 to the client computers 3.

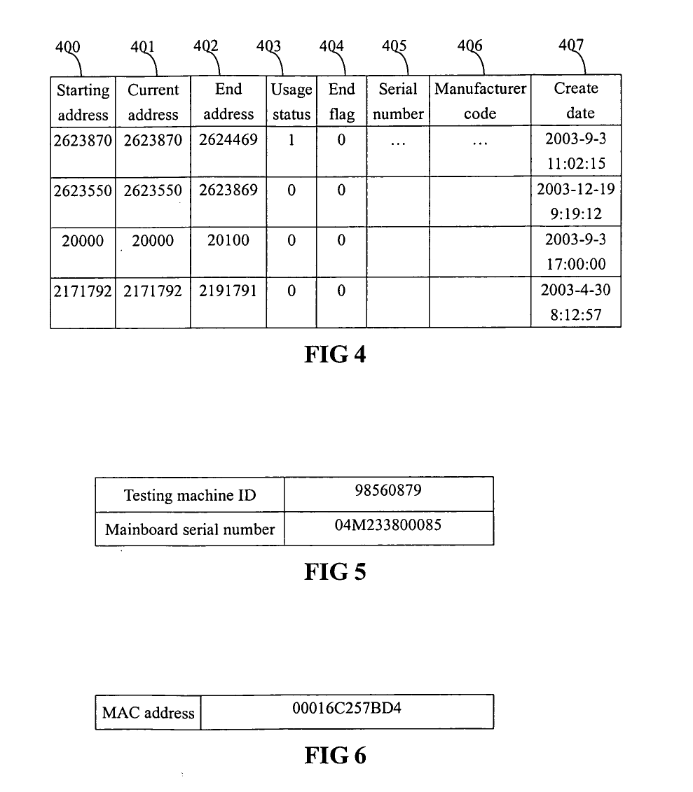

Referring to FIG. 4 there is shown details of the MAC address range table. The MAC address range table has 7 data columns: starting address 400, current address 401, end address 402, usage status 403, end flag 404, serial number 405, manufacturer code 406, and create date 407. The starting address 400 gives a starting address of an MAC address block. The current address 401 shows a current address of the MAC address block. The end address 402 shows an end address of the MAC address block. The usage status 403 may be any of the two values: “0” and “1.” “1” means the MAC address block is being in use, and “0” means the MAC address block has not been used. The end flag 404 is used to indicate whether MAC addresses in the MAC address block have been used up. The value “1” means the MAC addresses have been used up, and the value “0” means the MAC addresses have not been used up. The serial number 405 shows a serial number of the MAC address block in the MAC address range table. The manufacturer code 406 records a manufacturer code to which the MAC address block is allocated. The create date 407 records the time when the MAC address block is created.

Take the first row of the MAC address range table for example, the starting address of the MAC address block is 2623870, and the current address and end address are 2623870 and 2624469 respectively. The MAC address block is created at 11:02:15 on Sep. 3, 2003, and is now being in use.

Referring to FIG. 5, there are shown details of a .qry file. The .qry file includes a testing machine ID (e.g. 98560879) and a mainboard serial number (e.g. 04M233800085).

Referring to FIG. 6, there is shown an example of an .eth file. The .eth file at least includes an MAC address obtained from the MAC address range table (e.g. 00016C257BD4).

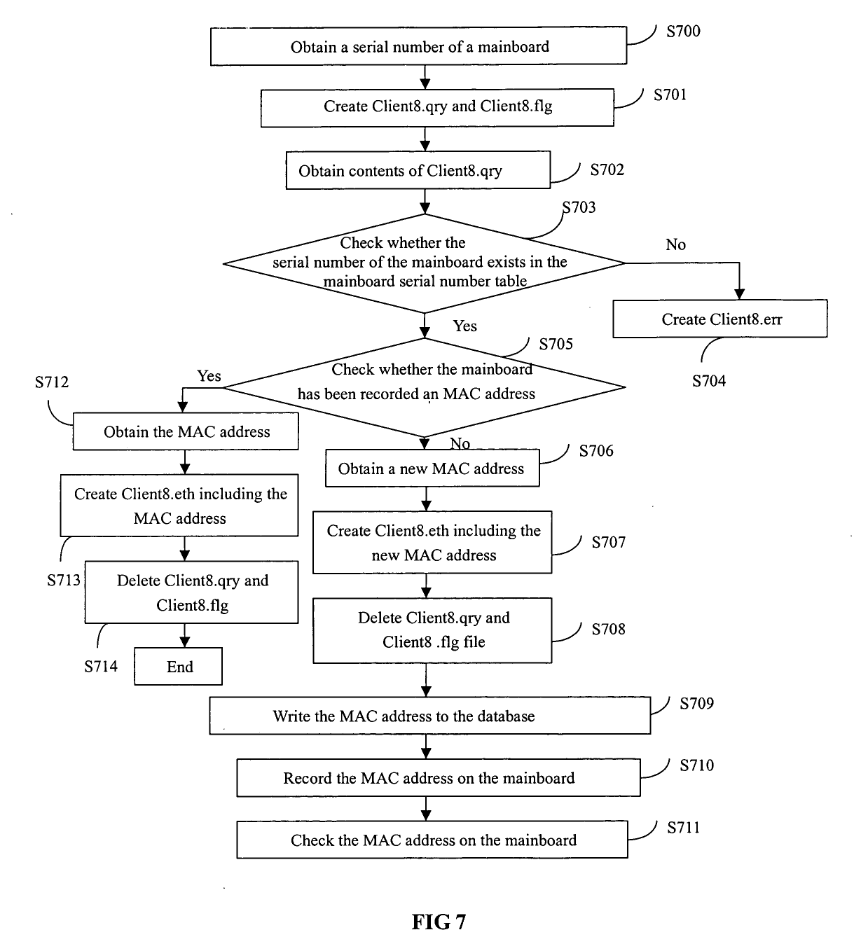

FIG. 7 is a flowchart of a preferred method for automatically allocating an MAC address to a mainboard. In step S700, a testing machine 2 scans a serial number of the mainboard. It is assumed in this preferred embodiment that an ID of the testing machine 2 is 98560879 and the serial number of the mainboard is 04M233800085. In step S701, the file creating module 32 creates a .qry file and a corresponding flg file according to a name of the client computer 3. It is assumed that the name of the client computer 3 is Client8. Therefore, the .qry file and the flg file can be respectively named as Client8.qry and Clinet8.flg. Client8.qry at least includes the serial number of the mainboard and the ID of the testing machine 2. Client8.flg is used to denote that Client8.qry has been successfully created. Then, the recording module 31 transmits Client8.qry and Client8.flg to the network folder 101, and transmits a recording request to the MAC address server 1 according to Client8.qry. In step S702, the searching module 11 searches all flg files in the network folder 101. If Client8.flg exists in the network folder 101, the reading module 12 opens Client8.qry and obtains contents therein. In step S703, the checking module 13 checks whether the serial number of the mainboard exists in the mainboard serial number table. If the serial number does not exist in the mainboard serial number table, in step S704, the creating module 14 creates a file named as Client8.err which records information on failure of automatically allocating an MAC address to the mainboard, and transmits Client8.err to the client computer 3. Otherwise, if the serial number exists in the mainboard serial number table, in step S705, the checking module 13 checks whether the mainboard has been recorded an MAC address, by determining whether an MAC address corresponding to the serial number of the mainboard is empty.

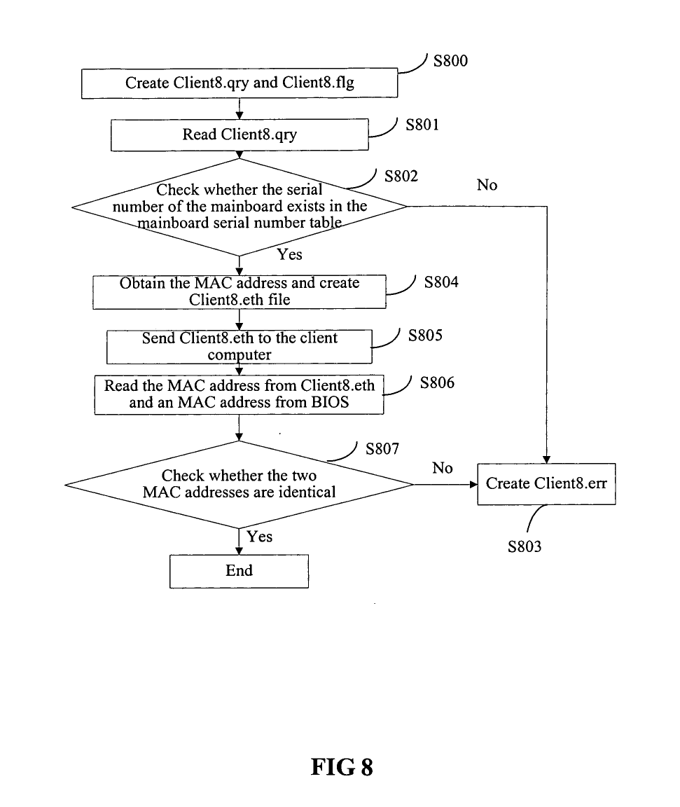

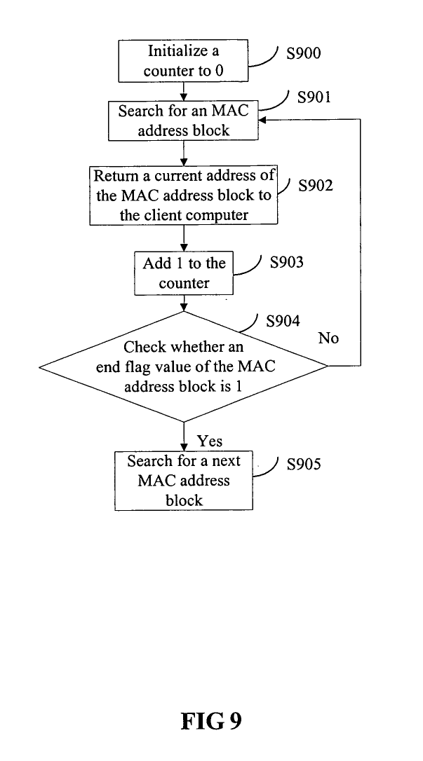

If the MAC address is not empty, which means the mainboard has been recorded an MAC address, the procedure goes directly to step S712 described below. If the MAC address is empty, then in step S706, a new MAC address is obtained from the MAC address range table (described in detail in relation to FIG. 9). In step S707, the creating module 14 creates Client8.eth including the new MAC address, and returns Client8.eth to the client computer 3. In step S708, the MAC address server 1 deletes Client8.qry and Client8.flg. In step S709, the file obtaining module 33 obtains Client8.eth. The recording module 31 reads the MAC address in Client8.eth and sends the MAC address to the testing machine 2. The file obtaining module 33 also writes the MAC address to the mainboard serial number table and the MAC address table. In step S710, the client computer 3 sends the MAC address to the testing machine 2 for recording the MAC address on the mainboard. In step S7 11, the verifying module 35 sends a checking request to the MAC address server 1 to check whether the MAC address recorded is correct. Details of step S711 are described below in respect to FIG. 8.

In step S712, the MAC address server 1 directly reads the MAC address from the mainboard serial number table. In step S713, the creating module 14 creates Client8.eth and returns Client8.eth to the client computer 3. In step S714, the creating module 14 deletes Client8.qry and Client8.flg, whereupon the procedure ends.

FIG. 8 is a flowchart of details of step S711, namely, checking whether the MAC address recorded is correct. In step S800, the client computer 3 sends a checking request to the MAC address server 1, meanwhile, the file creating module 32 creates Client8.qry including the serial number of the mainboard and Client8.flg. Then, the client computer 3 sends Client8.qry and Client8.flg to the network folder 101. In step S801, the reading module 12 reads Client8.qry. In step S802, the searching module 13 searches in the database 100, in order to check whether the serial number exists in the mainboard serial number table. If the serial number does not exist, in step S803, the creating module 14 creates Client8.err, and the sending module 15 sends Client8.err to the client computer 3. If the serial number exists in the mainboard serial number table, in step S804, the reading module 12 obtains the MAC address according to the serial number. Then, the creating module 14 creates Client8.eth. In step S805, the sending module 15 sends Client8.eth to the client computer 3. In step S806, the recording module 31 reads the MAC address from the Client8.eth, and reads an MAC address from the BIOS of the mainboard. In step S807, the determining module 34 checks whether the MAC address in Client8.eth and the MAC address in the BIOS are identical. If the two MAC addresses are not identical, the procedure goes to step S803 described above. If the two MAC addresses are identical, that means the MAC address has been successfully recorded on the mainboard, then the procedure ends.

FIG. 9 is a flowchart of details of step S706, namely, obtaining an MAC address from the MAC address range table. In step S900, the MAC address server 1 initializes a counter to zero. In step S901, the searching module 11 searches in the MAC address range table for an MAC address block with a usage status value being “1” and an end flag value being “0” according to a corresponding manufacturer code. In step S902, the MAC address server 1 returns a current address of the MAC address block to the client computer 3. In step S903, the counter is added by 1. In step S904, the checking module 13 checks whether the end flag value of the MAC address block is “1.” If the end flag value of the MAC address block is “1,” that means the MAC addresses in the MAC address block have been used up, then in step S905, the searching module 11 searches for a next MAC address block. If the end flag value is “0,” the procedure goes to step S901 described above.

While the invention has been described in terms of a single preferred embodiment, those skilled in the art will recognize that the invention can be practiced with modification within the spirit and scope of the appended claims.

We claim:

1. A system for automatically allocating MAC (Media Access Control) addresses to network cards integrated on mainboards, the system comprising:
a plurality of testing machines for recording the MAC addresses on the network cards;
an MAC address server comprising:
a database for storing MAC address information;
a network folder for storing kinds of designated format files used in the recording process; and
a plurality of client computers connected to the testing machines and the MAC address server for controlling the testing machines to record the MAC addresses on the network cards and verify the MAC addresses.

2. The system as claimed in claim 1, wherein the designated format files stored in the network folder comprises:
query files for requesting the MAC address server to allocate the MAC addresses to the network cards;
flag files used as marks denoting that corresponding query files have been created;
.eth files for storing the MAC addresses; and
error files for recording errors occurring in the recording of the MAC addresses.

3. The system as claimed in claim 2, wherein the MAC address server comprises:
a searching module for searching a flag file in the network folder according to a request of recording an MAC address to a network card from a client computer;
a reading module for opening a query file corresponding to the flag file and reading a mainboard serial number from a mainboard serial number table;
a checking module for checking whether an MAC address has been recorded on the network card; and
a creating module for creating an eth file including an MAC address obtained and an error file when any error occurs during the recording of the MAC address on the network card.

4. The system as claimed in claim 3, wherein each of the client computers comprises:
a recording module for sending the request of recording an MAC address to a network card to the MAC address server;
a file creating module for creating the query file and the flag file;
a file obtaining module for obtaining the eth file and the error file from the MAC address server;
a determining module for determining whether the MAC address included in the .eth file is identical to a corresponding MAC address in a BIOS (Basic Input/Output System) of the mainboard; and
a verifying module for sending a request to the MAC address server for verifying the MAC address recorded on the network card.

5. A method for automatically allocating an MAC (Media Access Control) address to a network card on a mainboard, the method comprising:
obtaining a serial number of the mainboard;
creating a query file and a flag file;
checking whether the serial number of the mainboard exists in a mainboard serial number table;
checking whether the network card has been recorded an MAC address if the mainboard serial number exits in the mainboard serial number;
obtaining a new MAC address from an MAC address range table if the network card has not been recorded an MAC address;
deleting the query file and the flag file;
recording the MAC address on the network card; and
checking the MAC address on the network card.

6. The method as claimed in claim 5, wherein the step of checking whether the serial number of the mainboard exists in a mainboard serial number table comprises the step of creating an error file if the serial number of the mainboard does not exist in the mainboard serial number table.

7. The method as claimed in claim 5, wherein the step of checking whether the network card has been recorded an MAC address comprises the steps of:
obtaining the MAC address if the network card has been recorded an MAC address; and
deleting the query file and the flag file.

8. The method as claimed in claim 5, wherein the step of checking the MAC address on the network card comprises the steps of:
creating a query file and a flag file;
checking whether the serial number of the mainboard exists in the mainboard serial number table;
obtaining the MAC address if the serial number of the mainboard exists in the mainboard serial number table;
reading an MAC address from a BIOS (Basic Input/Output System) of the mainboard; and
checking whether the two MAC addresses are identical.

9. The method as claimed in claim 8, wherein the step of checking whether the two MAC addresses are identical comprises the step of creating an error file if the two MAC address are not identical.

10. The method as claimed in claim 5, wherein the step of obtaining a new MAC address from an MAC address range table comprises the steps of:
initializing a counter to 0;
searching for an MAC address block;
obtaining a current address of the MAC address block;
adding 1 to the counter;
checking whether an end flag value of the MAC address block is 1; and
searching for a next MAC address block if the end flag value is 1.

11. The method as claimed in claim 10, wherein the step of checking whether an end flag value of the MAC address block is 1 comprises the step of returning to the step of searching for an MAC address block if the end flag value is not 1.

12. A method for automatically allocating an media access control (MAC) address to a mainboard, comprising the steps of:
retrieving an identifiable serial number of said mainboard;
verifying said serial number of said mainboard in caparison with a table showing serial numbers of mainboards which have been allocated for one of said MAC address;
allocating a new one of said MAC address to said mainboard in case that said serial number of said mainboard is not shown in said table;
recording said allocated one of said MAC address onto said mainboard; and
verifying said recorded one of said MAC address from said mainboard in comparison with said allocated one of said MAC address.

13. The method as claimed in claim 12, further comprising the step of allocating said one of MAC address shown in said table together with said serial number of said mainboard to said mainboard so as to be recorded onto said mainboard.

14. The method as claimed in claim 12, further comprising the step of generating a query file for executing said number-verifying step in a network folder.
